(19) United States
(12) Patent Application Publication
(10) Pub. No.: US 2022/0340484 A1
(43) Pub. Date: Oct. 27, 2022

(54) COATING-REMOVAL DEVICE AND METHOD FOR REMOVING COATINGS FROM GLASS PANES, AND METHOD FOR PRODUCING GLASS PANES FOR STEPPED-EDGE GLASS, STEPPED-EDGE GLASS AND STEPPED-EDGE GLASS WINDOW AND USE OF THE GLASS PANE FOR AN INSULATING GLAZING UNIT, IN PARTICULAR FOR STEPPED-EDGE GLASS OF A STEPPED-EDGE GLASS WINDOW

(71) Applicant: HEGLA boraident GmbH & Co. KG, Beverungen (DE)

(72) Inventor: Thomas Rainer, Wernigerode (DE)

(21) Appl. No.: 17/640,555

(22) PCT Filed: Sep. 4, 2020
(86) PCT No.: PCT/EP2020/074827

§ 371 Date: Mar. 4, 2022

(30) Foreign Application Priority Data
Sep. 6, 2019 (DE) 10 2019 213 603.6

(51) Int. Cl. C03C 23/00; C03C 19/00

(52) U.S. Cl. CPC C03C 23/0025; C03C 19/00; C03C 2218/328

(57) ABSTRACT

The present invention relates to a coating-removal device and to a coating-removal method for removing coatings at the edge of glass panes and to a method for producing glass panes for stepped-edge glass, to stepped-edge glass and to stepped-edge glass window with such stepped-edge glass.

The present invention relates to a decoating device and a decoating method for edge decoating of glass sheets, as well as a method for producing glass sheets for stepped glass, a stepped glass and a stepped glass window comprising such a stepped glass. The invention also relates to the use of the glass sheets for an insulating glazing, in particular for a stepped glass of a stepped glass window.

Flat glass is defined as any glass in the form of glass sheets, regardless of the manufacturing process used.

Laminated glass sheets are a laminate of at least two individual glass sheets, each bonded together by means of an adhesive intermediate layer of plastic, in particular by a highly tear-resistant, viscoplastic, thermoplastic film. Flat glass sheets can thus consist of a single glass sheet (single glass sheets) or of several glass sheets bonded together (laminated glass sheets).

In order to provide flat glass sheets with filtering, mirroring, heating or other functions, a wide variety of single- or multilayer functional coatings are applied to the individual flat glass sheets. The functions can be, for example, thermal insulation, sun protection or heating. The individual functional layers are usually metallic layers. For example, they are low-emission layers or electrical heating layers. One or more dielectric (functional) layers, e.g. of an oxide such as aluminum oxide, can be arranged between the individual metallic functional layers of a functional coating.

The individual functional layers are preferably applied to flat glass raw sheets of maximum commercial size (6.100 mm×3.250 mm). Individual sheets are then cut from these large-area coated flat glass raw sheets as needed, which are then further processed into functional units. These functional units can be, for example, insulating glass units or insulating glazings, with the sheet edges of the single sheets being bonded using, for example, spacer devices. Edge bonding adhesives are used for this edge bonding, whereby the edge bonding adhesives are designed exclusively for direct bonding to glass surfaces and not to the functional layers. The flat glass sheets must therefore be decoated in the bonding area, with the decoating width being about 10 mm, for example. Without decoating, reliable adhesion of the edge bonding adhesive cannot be guaranteed. This process is known as edge decoating.

The edge decoating takes place along the borders of the glass sheets and/or along later cutting or scoring or separating lines along which the flat glass raw sheets are cut into individual glass sheets after decoating.

Usually, the functional coating is a single functional layer or a layer structure with several functional layers with a total thickness <2 μm, preferably <1 μm. The layer structure is usually obtained by deposition processes.

In the case of glass sheets already cut to final size, edge decoating takes place, for example, along the borders of the glass sheet in single decoating width.

In the case of glass raw sheets or raw glass sheets, decoating is carried out in double decoating width on both sides next to the later cutting or scoring or separating line. However, if the size of the glass sheet and the quality of the glass sheet borders are appropriate, it is also possible to carry out the decoating along the borders of the glass sheet with a single coating decoating width. In the area of the later cutting or scoring or separating lines, the decoating tracks produced are thus twice as wide as in the area of the glass sheet borders. When decoating the borders, however, it is a disadvantage that, due to running over the sharp edges with decoating tools, the latters can be heavily and asymmetrically worn.

The removal of the functional layers is carried out in the field, for example, by means of mechanical removal using grinding tools or by sandblasting.

However, it can also be done with gas burners.

From DE 41 18 241 C2, for example, it is known to use grinding devices for decoating.

DE 34 03 682 describes a process and an apparatus in which the decoating and the cutting process are combined, the decoating being carried out with gas burners.

The German utility model DE 20 2013 104 834 U1 concerns a table for processing non-metallic, transparent materials by laser radiation, in particular for removing metallic coatings, for example low-emission coatings, and other coatings, from glass.

EP 1 864 950 A1, WO 2016/096435 A1 and DE 10 2007 015 767 A1 also respectively disclose the decoating of glass substrates (flat glass, solar cell) using a laser. The material to be removed is in each case the functional layer.

Furthermore, for some time now there have been types of glass in which the functional coating or even just the uncoated glass surface (in the case of glass sheets without a functional coating) is protected by a peelable protective film (TPF=temporary protective film) or a polymer protective layer (e.g. EasyPro® from St. Gobain) to protect it from possible mechanical damage. The polymer protective layer is applied, e.g. by spraying, and is not removable but firmly bonded to the respective surface. However, it burns off during annealing in the oven without any problems and without any residues.

For further processing of the glass sheets, e.g. for the insulating glass production, the protective film or the polymer protective layer must of course also be removed, analogously to the functional layers, at least at the later edge areas. The removal of the protective film or the polymer protective layer is currently carried out mechanically by means of a grinding tool, in particular by means of a grinding wheel or a grinding disc. If the glass sheet has a functional coating, the protective film or the polymer protective layer and the functional coating are ground off in one single operation.

The German patent application DE 10 2018 107 697.5, which has not yet been published, also describes a decoating process in which, for edge decoating, the protective film is mechanically removed, in particular ground off, in areas in the form of at least one film strip. In addition, before the film strip is mechanically removed, laser tracks are introduced into the protective film in such a way that the film strip is removed in the form of individual film strip sections separated from one another by the laser tracks. Preferably, a functional coating arranged under the protective coating is also removed at the same time as the film strip sections are mechanically removed, in particular by grinding.

According to a further decoating process disclosed in DE 10 2018 107 697.5 for glass sheets which have a protective coating in the form of a non-peelable polymer protective layer on at least one of their two glass surfaces and preferably a functional coating arranged underneath, the polymer protective layer is removed by means of laser radiation. The functional coating is then removed after the removal of the polymer protective layer by means of laser radiation or mechanically, in particular ground off.

As already explained, edge decoating is necessary in order to be able to bond the individual glass sheets of the insulating glazing at the edge with a spacer to form an insulating glazing.

A special form of an insulating glazing is a stepped glass for the production of a stepped glass window.

Stepped glass windows are also called “frameless windows”, although they have a window frame. However, this is much smaller than in conventional window designs. A stepped glass consists of an insulating glazing in which the outer glass sheet projects the other glass sheet(s), such that a step is formed. The projecting part of the outer glass sheet covers the sash frame. So that the sash frame is not visible, the outer glass sheet has a colored coating on its inner glass sheet surface. This gives the stepped glass window a frameless appearance.

In order for the colored coating to be applyable, it is necessary that the glass sheet surface does not have a functional coating in this area. This is because the functional coating is visually distracting.

As a result, glass sheets coated by means of fixed-dimension coating are usually used for stepped glass. In fixed-dimension coating, the glass sheet surface is coated with the functional coating in a masked condition. The masking is usually done with an adhesive tape. The adhesive tape covers the area of the glass sheet surface to be printed with paint later, so that this area is not coated with the functional coating. The glass sheets to be coated are also border-machined glass sheets already cut to final size.

This coating process is very time consuming and expensive, because the adhesive tape is used for masking. On the one hand, the adhesive tape is already very expensive, as it must be removable without leaving any residue, as well as being heat-resistant, and therefore only a special adhesive tape can be used. In addition, the adhesive tape is usually applied by hand.

Furthermore, in fixed-dimension coating, the glass sheets are usually coated in batches to save costs. This means that glass sheets with the same dimensions are combined into batches. As a result, the delivery time is usually relatively long.

Stepped glass can be used, for example, for structural glazing (SG) facades. These are glass facades in which the glass elements are held in the load-bearing system by bondings and can have a stiffening effect.

The object of the present invention is to provide an edge decoating process for removing the functional coating and, if present, a protective layer covering the functional coating, from glass sheets, e.g. laminated glass sheets, wherein the decoating is to be carried out simply, quickly, safely and inexpensively and the decoated glass surface is to have a high surface quality. The glass sheets are preferably used for the production of a stepped glass.

A further object of the invention is to provide a decoating device for carrying out the decoating process.

In addition, a method of manufacturing glass sheets for stepped glass, an insulating glazing, preferably a stepped glass, and a stepped glass window having such a stepped glass shall be provided.

In addition, advantageous uses of the decoated glass sheets should be indicated.

These objects are solved by a decoating process according to claim 1, a decoating device according to claim 17, a process for producing glass sheets for stepped glass according to claim 23, an insulating glazing, preferably a stepped glass, according to claim and 24, and a stepped glass window according to claim 26 and uses according to claims 27 and 29. Advantageous further embodiments of the invention are characterized in the following subclaims.

In the following, the invention is explained in more detail with the aid of a drawing by way of example. It shows:

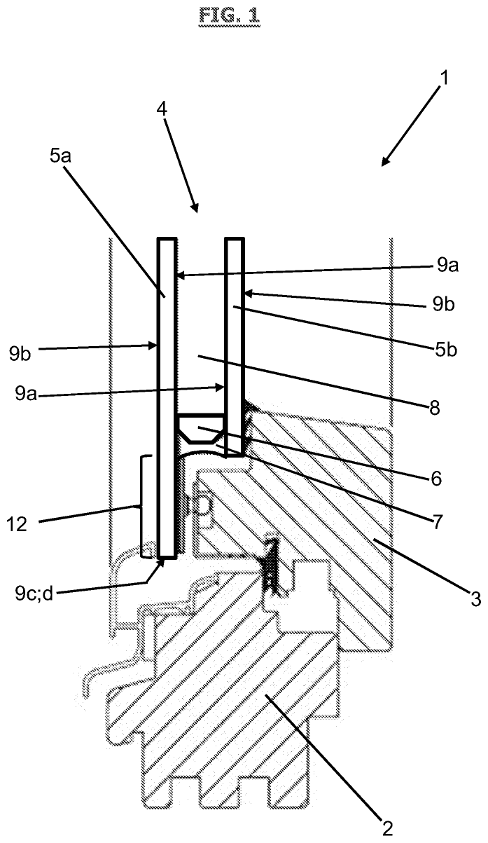

FIG. 1: Highly simplified and schematically a cross section through part of a stepped glass window

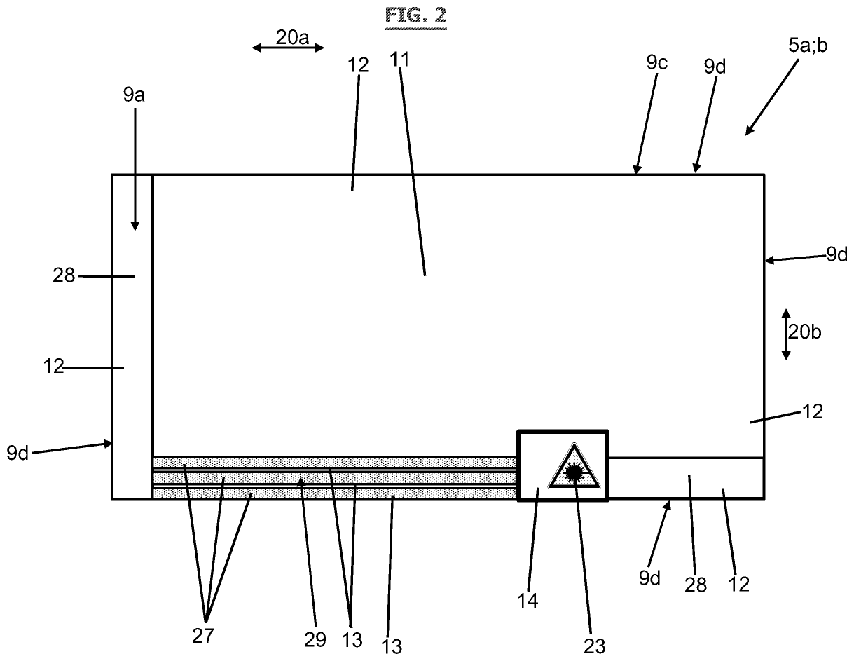

FIG. 2: Highly simplified and schematically a top view of a partially edge-decoated glass sheet

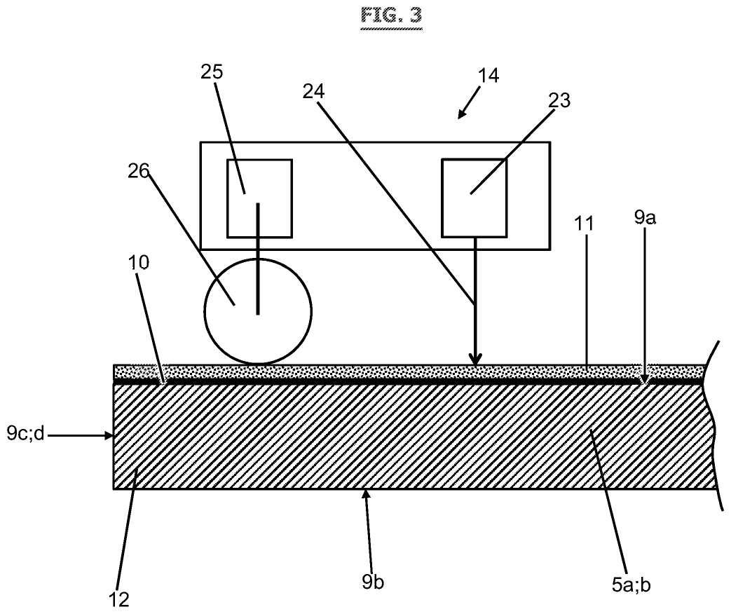

FIG. 3: Highly simplified and schematically a section through a glass sheet with a decoating device according to the invention arranged above it

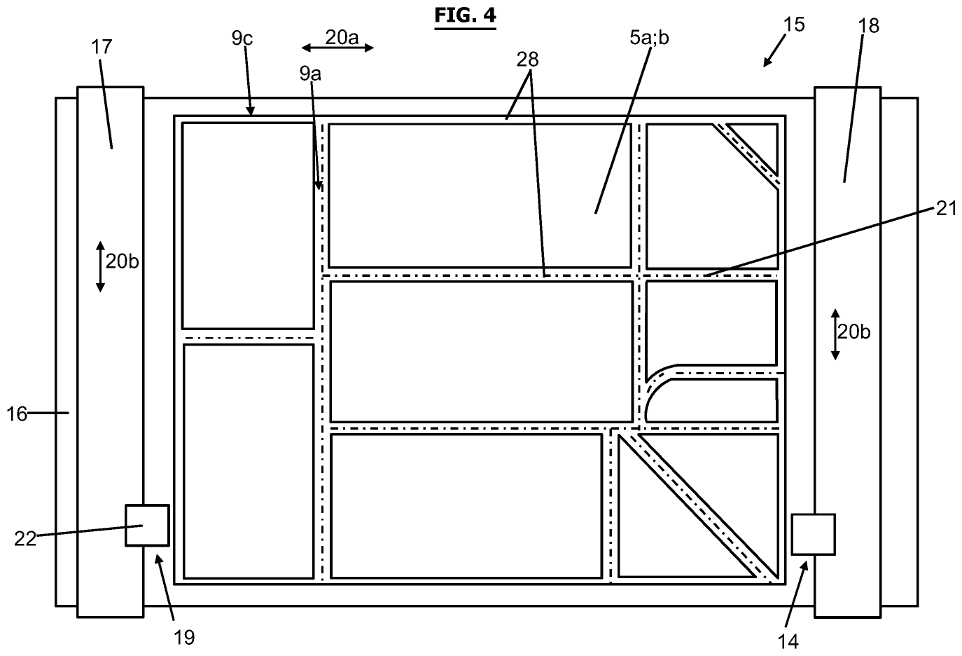

FIG. 4: Highly simplified and schematically a top view of a cutting and decoating station with a decoating device according to the invention with an edge-decoated glass sheet with decoating tracks

A stepped glass window 1 (FIG. 1) has, in a manner known per se, a blind frame 2, a sash frame 3 and a stepped glass 4 bonded into the sash frame 3. The stepped glass 4 is designed as an insulating glazing and thus has at least two spaced-apart glass sheets 5a;b, a spacer frame 6 arranged therebetween, a primary seal (not shown) and an edge seal (secondary seal) 7. The primary seal is present in a manner known per se between the spacer frame 6 and the respective glass sheet 5a;b and bonds them together.

Between the two glass sheets 5a;b there is a sheet intermediate space or sheet interior space or a gap 8. To ensure that this predefined interior space 8 is permanently maintained, the circumferential spacer frame is provided between the two glass sheets 5a;b. The spacer frame 6 connects the two glass sheets 5a;b to each other in the sheet edge area.

The two glass sheets 5a;b can each be a single glass sheet or a laminated glass sheet consisting of at least two single glass sheets.

The glass sheets 5a;b (FIGS. 1-4) also each have first and second glass sheet surfaces 9a;b and a circumferential glass sheet peripheral border 9c. The glass sheet peripheral border 9c has glass sheet borders 9d adjoining one another in pairs. If the glass sheet 5 is cuboidal, it has four glass sheet borders 9d adjoining one another in pairs.

In addition, at least the outer glass sheet 5a has a surface functional coating 10 at least on its inner glass sheet surface 9a. The functional coating 10 may have one or more individual functional layers. Thus, if there are multiple functional layers, it is a functional layer laminate. The functional layers change certain properties of the glass sheet 5a;b or impart certain functions thereto. The functions can be, for example, heat protection, sun protection, or heating. The individual functional layers are preferably metallic layers, e.g. low-emission layers.

The functional coating 10 preferably comprises a thickness of <2 μm, preferably <1 μm.

Furthermore, before being installed, the glass sheets 5a;b can have a protective coating 11 on at least one of their two glass sheet surfaces 9a;b, preferably in the form of a peelable protective film or a polymer protective layer. The protective coating 11 covers the respective glass sheet surface 9a;b to the outside and protects the functional coating 10 arranged underneath from mechanical damage. The protective coating 11 thus forms the outer or external layer of the glass sheet 5a;b.

In contrast to the functional coating 10, the protective coating 11 is completely removed before final use of the glass sheet 5a;b. It is therefore not permanently present. The protective film is peeled off and the polymer protective layer is burned off. A functional coating 10, on the other hand, is permanently present, at least in some areas.

The protective film is preferably made of plastic, preferably polyvinyl chloride (PVC), and is removable from the glass sheet surface 9a;b. In addition, the protective film preferably has a thickness of 20 to 100 μm.

The polymer protective layer consists of a polymer and cannot be peeled off from the glass sheet surface 9a;b. The polymer protective layer is firmly bonded to the functional coating 10. In addition, the polymer protective layer preferably has a thickness of 1 mm.

In addition, since the insulating glazing is a stepped glass 4 (FIG. 1), the outer glass sheet 5a projects over the inner glass sheet 5b at least in the region of one of its glass sheet borders 9d, preferably in the region of all glass sheet borders 9d. In this way a step is formed between the two glass sheets 5a;b. The outer glass sheet 5a thus has at least one glass sheet area 12 projecting over the inner glass sheet 5b. The projection of the outer glass sheet 5a over the inner glass sheet 5b or the length of the projecting glass sheet area 12 is preferably 10 to 500 mm in each case, preferably 100 to 300 mm.

The projecting glass sheet area 12 overlaps or covers the sash frame 3. In order the sash frame 3 being not visible, the projecting glass sheet area 12 has a colored coating on the inner glass sheet surface 9a. This gives the stepped glass window 1 a frameless appearance.

In order for the colored coating to be applyable to the projecting glass sheet area 12, it is necessary to decoat the inner glass sheet surface 9a in the area of the projecting glass sheet area 12. This means that the inner glass sheet surface 9a must be decoated not only in the area where it is bonded to the spacer frame 6, but also in the area of the projecting glass sheet area 12. During decoating, the functional coating 10 and, if applicable, the protective coating 11 must be removed.

Within the scope of the invention, it was found that purely mechanical decoating, e.g. by means of grinding, does not provide a decoated glass sheet surface 9a;b of sufficiently good quality. Rather, strip-like or linear residues of the functional coating 10 remain. As a result, the decoated glass sheet surface 9a;b has a grooved structure. It has a milky appearance.

If the mechanical decoating was carried out with more contact pressure, the functional coating 10 would be removed without residue. However, this would also damage the sensitive glass sheet surface 9a;b, which would also not result in a sufficiently smooth surface.

According to the invention, therefore, the functional coating 10 and, if present, the protective coating 11, are first removed mechanically, preferably by grinding, and remaining coating residues 13 are subsequently removed by laser. The high-quality glass sheet surface 9a;b produced in this way can then be coated in color.

Decoating according to the invention is preferably carried out by means of a decoating device 14 (FIGS. 2-4). The decoating device 14 is preferably integrated in a cutting and decoating station 15 (FIG. 4).

The cutting and decoating station 15 (FIG. 4) preferably has a support table 16 for receiving a glass sheet 5a;b, a first traversing bridge 17, a second traversing bridge 18, a cutting device 19 and the decoating device 14 according to the invention.

The two traversing bridges 17;18 span the top and/or bottom of the support table 16 and can each be moved back and forth over the glass sheet 5a;b in a first traversing direction 20a. Corresponding drive means are provided for this purpose. The first travel direction 20a is parallel to a glass sheet plane or to the two glass sheet surfaces 9a;b.

The cutting device 19 is used in a manner known per se for cutting or scoring the glass sheet surface(s) 9a;b along predetermined scoring or separating lines 21. If the glass sheet 5a;b is a single glass sheet, only one of the two glass sheet surface(s) 9a;b is scored. For this purpose, the cutting device 19 has, in a manner known per se, a cutting head 22 with a scoring tool, preferably a cutting wheel. In a manner known per se, the cutting head 22 is mounted on the first traversing bridge 17 so as to be movable in a second traversing direction 20b. Corresponding drive means are provided for this purpose. The second traverse direction 20b is perpendicular to the first traverse direction 20a and also parallel to a glass sheet plane or to the two glass sheet surfaces 9a;b. The cutting wheel is freely rotatable or driven rotatable about a horizontal axis of rotation which is parallel to the glass sheet plane or to the two glass sheet surfaces 9a;b. In addition, the cutting wheel is freely rotatable or driven rotatable about a vertical axis of rotation which is perpendicular to glass sheet plane or to the two glass sheet surfaces 9a;b. In this way, any cutting contours can be produced in a manner known per se.

In the case of a laminated glass sheet, both glass sheet surface(s) 9a;b are scored in a manner known per se, preferably simultaneously. The glass sheet 5a;b is then scored on the upper and lower sides, preferably simultaneously. Two cutting heads 22 arranged one above the other are provided for this purpose.

As already explained, according to the invention, the decoating device 14 is used for decoating the glass sheet 5a;b by mechanical decoating and subsequent laser decoating (laser ablation). For this purpose, the decoating device 14 has a laser beam generating device 23 for generating a laser beam 24 and a grinding head 25.

In addition, the decoating device 14 is mounted on the second traversing bridge 18 so that it can be moved in the second traversing direction 20b. Corresponding drive means are provided for this purpose.

As explained above, the grinding head 25 is used in accordance with the invention to remove the functional coating 10 and, if necessary, the protective coating 11 in the form of strips or paths. For this purpose, the grinding head 25 has at least one grinding tool, preferably at least one grinding disc or grinding wheel 26, in a manner known per se.

The grinding wheel or grinding disc 26 is freely rotatable or driven rotatable about a horizontal axis of rotation which is parallel to the glass sheet plane or to the two glass sheet surfaces 9a;b. In addition, the grinding wheel is freely rotatable or driven rotatable about 26a vertical axis of rotation which is perpendicular to the glass sheet plane or to the two glass sheet surfaces 9a;b. Thus, in combination with the movement of the decoating device 14 along the second traversing bridge 18, arbitrary decoating contours can be produced in a manner known per se.

The grinding wheel 26 or the grinding wheel also preferably has a width of 10 to 30 mm. As a result, the grinding wheel 26 can be used to decoate in strips, so that decoated strips 27 (FIG. 2) occur which have a width corresponding to the width of the grinding wheel 26.

As already explained, the laser beam generating device 23 is used to remove the coating residues 13. For this purpose, the laser beam generating device 23 generates the laser beam 24 directed to the glass sheet surface 9a. For this purpose, the laser beam generating device 23 has a laser beam source and an associated optical system. The laser beam 24 can be pivoted or deflected from an initial position in which it is aligned vertically.

Preferably, the laser radiation source is a diode laser or a fiber laser or a solid-state laser or a gas laser.

Preferably, the wavelength of the laser beam 24 is 300 nm to 10.6 μm, preferably 0.5 μm to 1.5 μm.

Or, preferably, the laser radiation source generates a laser beam 24 whose wavelength is in the infrared range.

In addition, the laser radiation source preferably generates a laser beam 24, the laser power of which is from 1 W to 10 kW, preferably from 10 W to 1 kW, particularly preferably from 500 W to 1 kW.

In addition, the laser beam 24 may be pulsed or continuous.

Furthermore, in the region of the glass sheet surface 9a, the laser beam 24 has either a round or an elongated, in particular linear, beam cross-section. The linear beam cross-section is preferred. The beam cross-section is generated by the optical system of the laser beam generating device 23.

In the following, the decoating process according to the invention will now be explained in more detail:

As already explained, the functional coating 10 and, if present, the protective coating 11 arranged above it are first ground off mechanically by means of the grinding wheel 26 in a manner known per se. In order to be able to grind off the desired contours, the grinding head 25 together with the grinding wheel 26 is moved in a manner known per se in the second traverse direction 20b along the second traverse bridge 18 and/or the second traverse bridge 18 is moved in the first traverse direction 20a. Thereby the grinding wheel 26 is rotated about its wheel rotation axis and, if necessary, pivoted about its vertical normal axis.

Since, particularly in the production of glass sheets 5a;b for stepped glass 4, the width of the area to be decoated is considerably greater than in conventional edge decoating and thus wider than the width of the grinding wheel 26, decoating is preferably carried out in paths or strips. This means that the grinding wheel 26 runs over the glass sheet surface 9a;b several times along mutually adjacent paths. By this, several mechanically decoated strips 27 adjacent to one another (FIG. 2) are produced. The mechanically decoated strips 27 arranged next to each other form an, in particular path-shaped, mechanically decoated area 29 or a mechanically decoated path 29.

The mechanically decoated area 29 or the individual decoated strips 27 each have coating residues 13. The coating residues 13 consist of functional coating material and, if applicable, also of protective coating material.

Furthermore, strip-shaped coating residues 13 may also be present between each of the mechanically decoated strips 27.

Alternatively, the grinding wheel 26 is moved in such a way that the mechanically decoated strips 27 intersect or overlap. In this case, too, however, there are usually linear coating residues 13 between the mechanically decoated strips 27.

The coating residues 13 are therefore subsequently removed by laser ablation in accordance with the invention. The coating residues 13 are completely removed, in particular vaporized or burned off.

For this purpose, the laser beam generating device 23 is moved along the mechanically decoated area 29, in particular the mechanically decoated strip(s) 27, and across the same. Preferably, for this purpose, the laser beam generating device 23 is moved in the second traverse direction 20b along the second traverse bridge 18 and/or the second traverse bridge 18 is moved in the first traverse direction 20a.

Thus, the laser beam 24 is moved by means of the optical system of the laser beam generating device 23 and/or by movement of the laser beam generating device 23 along the second traverse bridge 18 and/or by movement of the second traverse bridge 18.

If the laser beam 24 has a point-shaped beam cross-section, it is moved back and forth perpendicular to the direction of movement of the laser generating device 23, in particular by means of the optical system of the laser generating device 23. It thus oscillates transversely, in particular perpendicularly, to the longitudinal extension of the mechanically decoated area 29 and over the entire width of the mechanically decoated area 29. The optical system of the laser generating device 23 is namely capable, preferably with the aid of two adjustable mirrors (scanning optical system), of moving the laser beam 24 in an area (scanning field) of, for example, 100 mm×100 mm.

If the laser beam 24 has an elongated, in particular linear, beam cross-section, oscillation is not absolutely necessary. Preferably, in this case the laser line (which can also be slightly elliptical, for example) extends over the entire width of the mechanically decoated area 29. In addition, the laser line is preferably transverse, in particular perpendicular, to the longitudinal extension of the mechanically decoated area 29. Thus, all the mechanically decoated strips 27 arranged next to one another or the entire area 29 can be traversed and decoated simultaneously by means of the laser line in a single operation. This is particularly advantageous because the decoating is carried out much faster than with the oscillating laser beam 24 with the point-shaped beam cross-section.

Of course, however, the laser beam 24 with the elongated, in particular linear, beam cross-section can also oscillate if necessary, in particular if the length of the laser line is not sufficient, in order to pass over all the mechanically decoated strips 27 arranged next to one another simultaneously and thereby decoat them. Nevertheless, even in this case, the decoating is significantly faster than with the laser beam 24 with a point-shaped beam cross-section.

The laser beam generating device 23 thereby preferably passes only once over the mechanically decoated area 29, in particular the mutually adjacent mechanically decoated strips 27, and thereby removes all coating residues 13 of the mechanically decoated area 29, in particular the mutually adjacent mechanically decoated strips 27 and the coating residues 13 present therebetween, in one operation (see FIG. 2).

After laser decoating, the glass sheet surface 9a;b is completely decoated. After laser decoating, the glass sheet surface 9a;b thus has decoating tracks or decoating paths or decoating strips or decoating areas 28 in which the glass sheet surface 9a;b is completely decoated or decoated without residue.

Depending on whether a glass sheet 5a;b (FIG. 2) already cut to final size or a raw glass sheet 5a;b (FIG. 4) still to be cut is decoated, the width of the decoating tracks 28 corresponds to the single or double decoating width desired later for a glass sheet 5a;b having its final size. The later decoating width corresponds to the projection of the projecting glass sheet area 12 plus the width of a decoated area required for the edge seal.

In the case of a raw glass sheet 5a;b (FIG. 4) still to be cut, in the interior of raw glass sheet 5a;b, the areas on both sides and along the later cutting or scoring lines 21 still to be introduced are decoated. The decoating tracks 28 each extend along the later scoring or separating line 21 and on both sides next to it. In particular, the scoring or separating line 21 is arranged centrally within the decoating track 28. The raw glass sheet 5a;b is therefore decoated in double the decoating width on both sides next to the later scoring or separating line 21.

Along the glass sheet borders 9d, the decoating can be carried out in a single decoating width—if the dimensions of the raw glass sheet 5a;b are appropriate and the quality of the glass sheet borders 9d is sufficient.

The same applies to glass sheets 5a;b (FIG. 2) already cut to final size, where decoating only takes place along the glass sheet borders 9d, but no longer in the area inside the glass sheet borders 9d. Here, too, decoating is carried out in a single decoating width.

After decoating, the separating or scoring lines 21 are then generated on a raw glass sheet 5a;b by means of the cutting head 22, and then the raw glass sheet 5a;b is broken into individual glass sheets 5a;b to final size at the scoring or separating lines 21 in a manner known per se.

If the glass sheets 5a;b having their final dimensions are to be used for the production of a stepped glass 4, they are also color-coated in the later projecting glass sheet area(s) 12 in the region of the decoating tracks 28. The coating is preferably carried out by printing, preferably with ceramic paint, and subsequent baking of the paint. The printing can be done, for example, by means of screen printing. However, the coating can also be carried out, for example, by applying UV-curing paint.

The advantage of the decoating process according to the invention is that the glass sheets 5a;b for the stepped glass 4 can be produced flexibly by the stepped glass manufacturers themselves, without long delivery times of the fixed-dimension coater and by saving costs.

Since, according to the invention, only coating residues or rests 13 remaining from mechanical decoating are removed by means of laser decoating, laser decoating can be carried out at a significantly higher speed than in the case of complete laser decoating, in which the entire material is removed by laser. This is particularly noticeable in the decoating of glass sheets 5a;b for stepped glass 4, since here the width of the decoating tracks 28 is significantly greater than with conventional edge decoating.

Preferably, decoating tracks 28 with a width of at least 1 mm, preferably at least 20 mm are generated. Preferably, decoating tracks 28 with a width of 1 to 30 mm are generated.

Furthermore, the subsequent laser decoating compensates for the quality disadvantage of mechanical decoating, namely the leaving of residues 13 due to incomplete removal of the functional coating 10.

By means of the decoating process according to the invention, the decoating quality is thus very high. The “laser finishing” or “laser polishing” produces very smooth decoated surfaces that can be coated with paint and bonded without further ado. The surface is not damaged in the process.

Furthermore, as described, it is possible to integrate the decoating process into an existing glass cutting line, e.g. a laminated glass cutting line. The glass cutting line, e.g. the laminated glass cutting line, can then in turn be followed by a further processing line. The further processing line is preferably an insulating glass line for further processing of the glass sheets 5a;b to form insulating glazing, preferably a stepped glass line for further processing of the glass sheets 5a;b to form stepped glass 4. In the insulating glass line, preferably the stepped glass line, the edges of the glass sheets 5a;b are bonded to the spacer frame 6.

It is of course also within the scope of the invention that the cutting device 19 is separate from the decoating device 14, i.e. that it is arranged in a different station.

In addition, the grinding head 25 and the laser beam generation device 23 can also be decoupled from each other. This means that they can be moved separately from each other and/or can also be attached to different traversing bridges.

Preferably, however, they are coupled together or movable together. The cutting wheel 26 is then preferably liftably and lowerably attached to the grinding head 22 so that it can be engaged with and disengaged from the glass sheet 5a;b. Since the grinding head 25 and the laser beam generating device 23 are mechanically coupled, they are moved together or synchronously with each other along the decoating tracks 28 to be generated, the grinding head 25 being of course arranged upstream or ahead of the laser beam generating device 23 in the direction of travel.

In addition, the creation of the contours can also be achieved by the decoating device 14 being moveably on a stationary bridge and moving the glass sheet 5a;b during the decoating process. It is only important that the decoating device 14 together with the grinding wheel 26 and/or laser beam 24 and the glass sheet 5a;b perform corresponding relative movements to each other. The same applies to the cutting process.

Furthermore, it is of course also within the scope of the invention that there is only one traversing bridge and that the cutting device 19 and the decoating device 14 are arranged on the same traversing bridge. This is even preferred.

However, the grinding head 25 and the laser beam generating device 23 can also be located on different traverse bridges, although it is preferred otherwise.

Furthermore, the grinding wheel 26 may have a width equal to the width of the decoating track 28 to be produced so that only a single mechanically decoated strip 27 is sufficient.

In addition, the laser beam 24 can be directed directly at the coating residues 13, which is preferred, or be radiated through the glass sheet 5a;b.

Preferably, the mechanical removal is also carried out by grinding. However, it can also be done by sandblasting, for example.

The decoating process according to the invention is also advantageous for the production of glass sheets for conventional insulating glazing. The higher the surface quality in the bonding area, the higher the quality and durability of the bonding. This is because due to coating residues in the area of the bonding surface or damage to the glass surface (due to excessive mechanical decoating), channels can form over time through which the gas located in the space between the sheets escapes. At the same time, oxygen can diffuse into the space between the sheets. And this leads to discoloration of the functional coating due to oxidation.

### EXEMPLARY EMBODIMENT

A front panel for a structural glazing product with a commercially available thermal insulation layer (low-e layer) was mechanically decoated in the edge areas using a commercially available grinding disc, i.e. the majority of the low-e layer was removed from the glass sheet surface. The width of the mechanically decoated edge area was 10 mm on three sides and 100 mm on one side. After the mechanical edge decoating, among other things, linear residues from the functional coating remained. In the case of the 100 mm wide edge, the individual passes of the grinding disc were also visible, as residues of the functional coating remained on the edges of the strips mechanically decoated by one pass with the grinding disc. The decoated edge area was visible to the human eye as inhomogeneously decoated.

To remove this inhomogeneity, the decoated edge area was additionally irradiated with a laser device (fiber laser, wavelength=1.06 μm, power=20 W) by oscillating the point-shaped cross-section of the laser beam (radius=100 μm) over the decoated edge area. This evaporated the residues of the functional coating that remained on the glass surface after mechanical edge decoating. After this process, the edge area had the appearance of an uncoated glass surface and was completely homogeneous.

1. A decoating method for edge decoating of glass sheets,
wherein the glass sheets have a functional coating on at least one of their two glass sheet surfaces,
wherein, for edge decoating, the functional coating is mechanically removed, in particular ground off, in areas, wherein
coating residues remaining after mechanical removal of the functional coating are removed by means of laser radiation.

2. The decoating method according to claim 1, wherein
strip-shaped decoating tracks are produced on the glass sheets during decoating, the glass sheets being completely decoated in the region of the decoating tracks.

3. The decoating method according to claim 2, wherein
the decoating tracks having a width of at least 1 mm, preferably of at least 20 mm,
and/or decoating tracks having a width of 1 to 30 mm are produced.

4. The decoating method according to claim 1, wherein
the coating residues are vaporized and/or burned by means of the laser radiation.

5. The decoating method according to claim 2, wherein
to produce a decoating track, decoating is in each case first carried out mechanically in the form of strips, wherein preferably a plurality of mutually adjacent, mechanically decoated strips are produced, the mechanically decoated strips having coating residues.

6. The decoating method according to claim 0, wherein
the mechanically decoated strips adjacent to each other are produced one after the other.

7. The decoating method according to claim 0, wherein
the coating residues of a mechanically decoated, path-shaped region, in particular the coating residues of the mechanically decoated strips adjacent to one another and, if applicable, the coating residues present between the mechanically decoated strips adjacent to one another, are removed in one operation by means of the laser radiation.

8. The decoating method according to claim 1, wherein
the glass sheets have a protective coating covering the functional coating, the protective coating being removed mechanically at the same time as the functional coating in a single operation.

9. The decoating method according to claim 8, wherein
the protective coating is a non-peelable polymer protective layer or a peelable protective film.

10. The decoating method according to claim 1, wherein
a laser beam having a wavelength in the infrared range or having a wavelength from 300 nm to 10, 0.6 μm, preferably from 0.5 μm to 1.5 μm, is used for laser ablation.

11. The decoating method according to claim 1, wherein
a laser beam having a laser power of 1 W to 10 kW, preferably of 10 W to 1 kW, preferably of 500 W to 1 kW, is used for laser ablation.

12. The decoating method according to claim 1, wherein
a laser beam having a point-shaped beam cross-section or having an elongated, in particular a linear, beam cross-section is used for laser ablation.

13. The decoating method according to claim 1, wherein
a laser beam having an elongated, in particular a linear, beam cross-section is used, and a laser line of the laser beam extends transversely to the longitudinal extension of the mechanically decoated region, preferably transversely to the longitudinal extension of the mutually adjacent mechanically decoated strips.

14. The decoating method according to claim 1, wherein
for laser ablation, an oscillating laser beam, preferably oscillating transversely to the longitudinal extension of the mechanically decoated region, preferably oscillating transversely to the longitudinal extension of the mutually adjacent mechanically decoated strips, is used.

15. The decoating method according to claim 13, wherein
the laser beam extends over the entire width of the mechanically decoated area, preferably over the entire width of the mutually adjacent mechanically decoated strips, and does not oscillate.

16. The decoating method according to claim 1, wherein
the means for mechanically removing the functional coating and the means for removing the remaining coating residues by means of laser radiation are moved together.

17. A decoating device for edge decoating of glass sheets, the glass sheets having a functional coating on at least one of their two glass sheet surfaces, the decoating device having a grinding device for grinding off the functional coating, wherein
the decoating device comprises a laser beam generating device for removing coating residues remaining after mechanical removal of the functional coating by means of laser radiation.

18. The decoating device according to claim 17, wherein
the laser beam generating device has means for generating a laser beam having a wavelength in the infrared range or having a wavelength from 300 nm to 10.6 μm, preferably from 0.5 μm to 1.5 μm.

19. The decoating device according to claim 17, wherein
the laser beam generating device comprises means for generating a laser beam having a laser power of from 1 W to 10 kW, preferably from 10 W to 1 kW, preferably from 500 W to 1 kW.

20. The decoating device according to claim 17, wherein
the laser beam generating device has means for generating a laser beam having a point-shaped beam cross-section or an elongated, in particular linear, beam cross-section.

21. The decoating device according to claim 17, wherein
the laser beam generating device has means, in particular an optical system, for oscillating the laser beam.

22. The decoating device according to claim 17, wherein
the grinding device and the laser beam generating device are mechanically coupled to each other in such a way that they can be moved together.

23. A method of manufacturing a glass sheet for a stepped glass, wherein the glass sheet is decoated adjacent to at least one of its glass sheet borders and a colored coating is subsequently applied to the decoated glass sheet surface, wherein
decoating is carried out according to claim 1.

24. An insulating glazing, in particular a stepped glass, having at least two glass sheets arranged parallel to one another and spaced apart from one another, and having a spacer frame which is arranged between the glass sheets and connects the two glass sheets to one another in the sheet edge region, wherein a sheet interior space being bounded by the glass sheets and the spacer frame, wherein
the insulating glazing, preferably the stepped glass, comprises at least one glass sheet (5a;b) being decoated according to claim 1.

25. An insulating glazing in the form of a stepped glass having at least two glass sheets arranged parallel to one another and spaced apart from one another, and having a spacer frame which is arranged between the glass sheets and connects the two glass sheets to one another in a sheet edge region, wherein a sheet interior space is bounded by the glass sheets and the spacer frame, wherein
one of the at least two glass sheets is an outer glass sheet comprising glass sheet borders, wherein the outer glass sheet projects beyond the at least one other glass sheets at least in a region of one of its glass sheet borders, preferably in a region of all of its glass sheet borders, wherein the outer glass sheet is produced according to claim 23.

26. A stepped glass window comprising a blind frame and a sash frame as well as a stepped glass inserted, preferably glued, into the sash frame, wherein
the stepped glass is a stepped glass according to claim 25.

27. A method of using a glass sheet for an insulating glazing, in particular for a stepped glass, having at least two glass sheets arranged parallel to one another and spaced apart from one another and having a spacer frame arranged between the glass sheets and connecting the two glass sheets to one another in a sheet edge region, wherein a sheet interior space is bounded by the glass sheets and the spacer frame, and wherein the glass sheet is produced in accordance with claim 23 and is used as one of the mutually parallel and mutually spaced glass sheets.

28. The method according to claim 27, wherein
the glass sheet is used as an outer glass sheet of a stepped glass, wherein the outer glass sheet comprises glass sheet borders and projects beyond the at least one other glass sheet at least in a region of one of its glass sheet borders, preferably in a region of all of its glass sheet borders.

29. The method of using according to claim 28, wherein the stepped glass forms part of a stepped glass window, which comprises a blind frame and a sash frame as well as the stepped glass inserted, preferably glued, into the sash frame.
